(19) United States
(12) Patent Application Publication
(10) Pub. No.: US 2009/0026139 A1
(43) Pub. Date: Jan. 29, 2009

(54) SUBMERGED CROSS-FLOW FILTRATION

(76) Inventors: Fufang Zha, New South Wales (AU); Thomas William Beck, New South Wales (AU)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/718,456

(22) PCT Filed: Oct. 26, 2005
(86) PCT No.: PCT/AU05/01662

§ 371 Date: May 2, 2007

(30) Foreign Application Priority Data
Nov. 2, 2004 (AU) 2004906322

(51) Int. Cl. B01D 63/04; B01D 61/14; B01D 63/02

(52) U.S. Cl. 210/650; 210/500.23; 210/321.78

(57) ABSTRACT

A membrane filtration module (5) of the type having a plurality of permeable, hollow membranes (6) mounted therein, wherein, in use, a pressure differential is applied across the walls of the permeable, hollow membranes (6) immersed in a liquid suspension containing suspended solids, said liquid suspension being applied to one surface of the permeable, hollow membranes (6) to induce and sustain filtration through the membrane walls wherein some of the liquid suspension passes through the walls of the membranes to be drawn off as clarified liquid or permeate, and at least some of the solids are retained on or in the permeable, hollow membranes (6) or otherwise as suspended solids within the liquid suspension, the module (5) including a fluid retaining means (13) at least partially surrounding the membrane module (5) for substantially retaining at least part of fluid flowed into the membrane module (5).

### TECHNICAL FIELD

The present invention relates to membrane filtration systems and more particularly to submerged membrane filtration systems and their operation.

### BACKGROUND OF THE INVENTION

The submerged membrane filtration process with air scrubbing emerged in 1980's. The driving force for filtration by suction or static head instead of pressurisation was the elimination of the need for a pressure vessel to contain membrane modules, resulting in significant savings on the capital expense of a membrane filtration system. The gas/air consumption, required to scrub the membranes, however, was found to be a dominant portion in operating energy used in such a filtration process which resulted in high than expected operating costs. Consequently, a lot of effort has been made to reduce the gas/air consumption since the introduction of such systems.

There have been two main directions followed to achieve this aim:
a) improving the membranes' property with low fouling rate and high permeability; and
b) improving the filtration/cleaning process.

There are a few significant factors that influence the scrubbing efficacy of a certain membrane. It has been found that the air could be more efficiently used by re-arranging modules to a smaller footprint. In this way the amount of air could be concentrated to more efficiently scour the membranes. The use of high packing density modules also saves air consumption per membrane area Intermittently scouring membranes with air instead of continuous injection is another way to save air consumption.

Another known method is to scrub the membrane with a mixture of gas and liquid. This method is of particular importance in the membrane bioreactor where the membrane filters the mixed liquor containing a high concentration of suspended solids and a recirculation of mixed liquor is required to achieve denitrification. This method exploits such a mixed liquor recirculation flow to scrub the membranes with air, to minimise the solid concentration polarisation near the membrane surface and to prevent the dehydration of mixed liquor. The design of the membrane module aims to achieve a uniform distribution of the two-phase mixture into the membrane bundles. Membranes in known modules are typically either freely exposed to the feed or restricted in a perforated cage. Therefore there is still a certain loss of energy during the fluid transfer along the modules.

In the early stage of membrane process development, cross flow filtration was commonly used, where a shear force was created by pumping a high velocity of feed across the membrane surface. Because more energy is required to create a high shear force to effectively clean the membrane, the application of the cross flow filtration process is now limited, mainly in the tubular membrane filtration field.

### SUMMARY OF THE INVENTION

It is an object of the present invention to overcome or ameliorate at least one of the disadvantages of the prior art, or to provide a useful alternative.

According to one aspect, the present invention provides a membrane filtration module of the type having a plurality of permeable, hollow membranes mounted therein, wherein, in use, a pressure differential is applied across the walls of the permeable, hollow membranes immersed in a liquid suspension containing suspended solids, said liquid suspension being applied to one surface of the permeable, hollow membranes to induce and sustain filtration through the membrane walls wherein some of the liquid suspension passes through the walls of the membranes to be drawn off as clarified liquid or permeate, and at least some of the solids are retained on or in the permeable, hollow membranes or otherwise as suspended solids within the liquid suspension, the module including a fluid retaining means at least partially surrounding the membrane module for substantially retaining at least part of fluid flowed into the membrane module.

According to a second aspect, the present invention provides a method of filtering solids from a liquid suspension using a plurality of permeable, hollow membranes mounted in a membrane module, the method including:

flowing a fluid containing said liquid suspension into said membrane module such that said liquid suspension is applied to one surface of the permeable, hollow membranes;

applying a pressure differential across the walls of the permeable, hollow membranes immersed in the liquid suspension containing suspended solids to induce and sustain filtration through the membrane walls wherein some of the liquid suspension passes through the walls of the membranes to be drawn off as clarified liquid or permeate, and at least some of the solids are retained on or in the permeable, hollow membranes or otherwise as suspended solids within the liquid suspension, and

substantially retaining at least part of the fluid flowed into the membrane module by at least partially surrounding the membrane module with a fluid retaining means.

Preferably, in one form, the fluid retaining means includes a sleeve substantially surrounding the periphery of the membrane module. For preference, the sleeve is liquid-impermeable and, more preferably, solid. Preferably, the sleeve is a box-like structure extending along the length of the module. It will be appreciated the term “box-like” includes any desirable cross-sectional shape suitable for the shape of the membrane module. For preference, the sleeve is provided with openings at one end to allow the flow of fluid therethrough. Preferably, in another form, the fluid retaining means includes at least one pair of opposed walls positioned on either side of the module. For preference, more than 50% of the module is enclosed by the fluid retaining means and, more preferably, 70% or above is enclosed.

Preferably, the fluid includes at least some of the liquid suspension. The liquid suspension can be delivered to the module in various ways, including by direct feeding or through a gas lifting effect. For preference, the fluid also includes gas and/or a gas/liquid mixture.

Preferably, the modules are submerged in a tank containing the liquid suspension and permeate is collected by applying a vacuum or static head to the membrane lumens. For preference, the membranes within the module extend between upper and lower headers and the liquid suspension and the gas are introduced beneath the lower header or in the vicinity of the lower header of the module. Preferably, the fluid is flowed into the module through openings in the lower header. The two-phase fluid then flows along the length of the module, creating a cross flow effect. Either liquid or gas, or both can be injected continuously or intermittently into the module.

### BRIEF DESCRIPTION OF THE DRAWINGS

Preferred embodiments of the invention will now be described, by way of example only, with reference to the accompanying drawings in which:

FIG. 1a shows a simplified sectional side elevation view of membrane module configuration according to an embodiment of the invention;

FIG. 1b shows a simplified sectional side elevation view of a known membrane module configuration having a screen;

FIG. 1c shows a simplified sectional side elevation view of known membrane module configuration with no restraint around the fibre membranes;

FIG. 2a shows a simplified perspective view of membrane module configuration according to another embodiment of the invention;

FIG. 2b shows a simplified perspective view of membrane module configuration according to another embodiment of the invention;

FIG. 2c shows a simplified perspective view of membrane module configuration according to another embodiment of the invention;

FIG. 2d shows a simplified perspective view of membrane module configuration according to another embodiment of the invention;

FIG. 3 shows a simplified perspective view of membrane module configuration according to yet another embodiment of the invention;

FIG. 4 shows a simplified perspective view of membrane module configuration according to yet another embodiment of the invention; and

FIG. 5 shows a simplified perspective view of membrane module configuration according to yet another embodiment of the invention.

### DESCRIPTION OF PREFERRED EMBODIMENTS

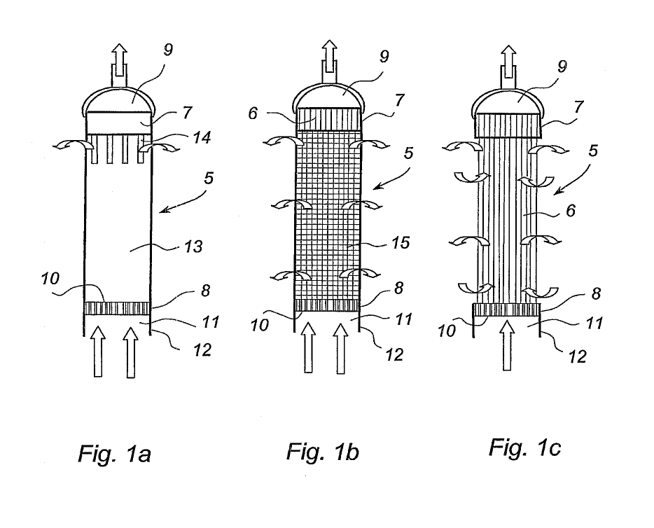

FIGS. 1a to 1c illustrate the operation of three different module configurations. The membrane module 5 in each configuration has a plurality of hollow fibre membranes 6 extending between upper and lower headers 7 and 8. The fibres 6 in the upper header 7 opening into a permeate collection chamber 9. The lower header 8 has a plurality of aeration openings 10 for feeding gas and/or liquid into the membrane module. An open mixing chamber 11 is provided below the lower header 8 and is usually formed by a downwardly extending skirt 12. A closed mixing chamber may also be used.

FIG. 1a is the configuration of one preferred embodiment of the invention. Gas, typically air, and liquid feed are injected into a membrane module 5 within a solid enclosure or sleeve 13 surrounding the periphery of the module 5. The liquid feed can also be introduced into the module 5 through the gas lifting. The gas/liquid mixture then flows upward along the module 5 creating a cross flow action. The gas bubbles and the concentrated feed are released at the upper header 7 of the module 5 through openings 14 in the upper portion of the enclosure 13.

The gas and feed liquid can be mixed in the open chamber 11 beneath the lower header 8, and then fed into the module 5. Alternatively, the two-phase fluid can be directly injected to the lower header 8 through a direct connection (not shown). Either gas or liquid, or both can be supplied continuously or intermittently.

FIG. 1b shows a known module configuration wherein a module 5 has a perforated screen 15. Although a mixture of gas and feed liquid is injected into the module 5, the gas bubbles can partly escape from any portion of the module 5 and the feed liquid may also escape through diffusion with the bulk feed liquid. Accordingly, the cross flow effect is reduced in such a configuration.

If no screen is used with the module 5 the membrane fibres 6 can move in a larger zone as shown in FIG. 1c. When gas and/or liquid feed is injected into the module 5, the membrane cleaning is achieved by gas scouring of swayable fibres as described in U.S. Pat. No. 5,783,083. The liquid near the membrane surface is refreshed by transfer with the bulk phase. The gas and liquid are free to escape from the confines of the module, thus there is little or no cross-flow effect.

U.S. Pat. No. 6,524,481 discloses the benefit of employing two-phase mixture to scrub membranes. When an enclosure is used to restrict the flow dispersal, the energy of both gas and liquid is more efficiently utilised.

It will be appreciated that this concept is easily applied to modules of other configurations, such as rectangular and square modules. The enclosure may be of any desirable cross-sectional shape suitable to the module including cylindrical, square, rectangular, or elliptical.

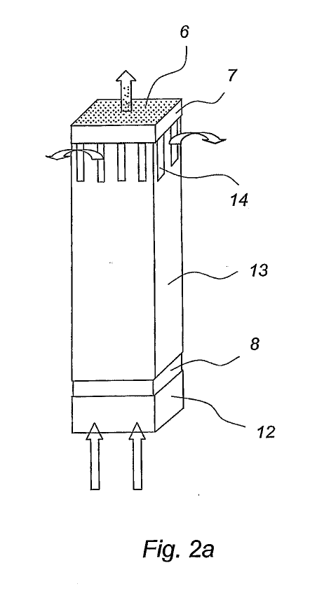

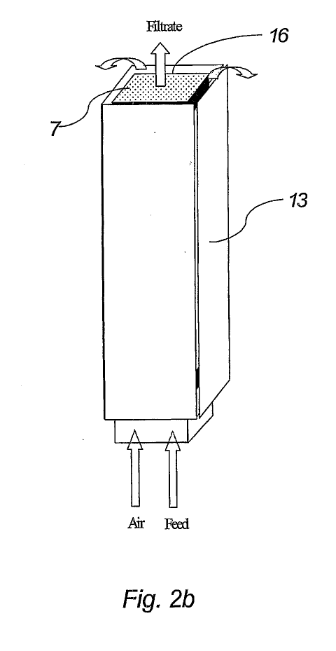

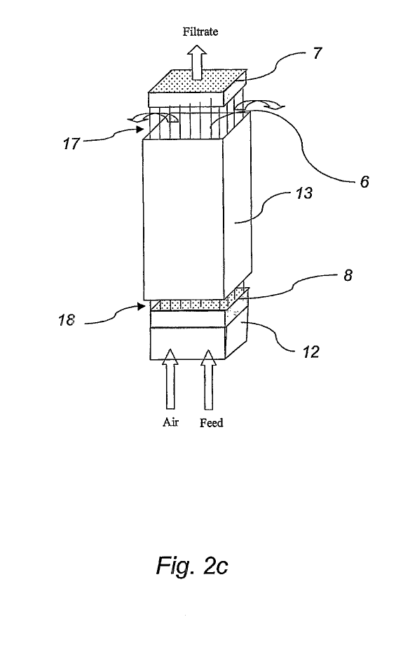

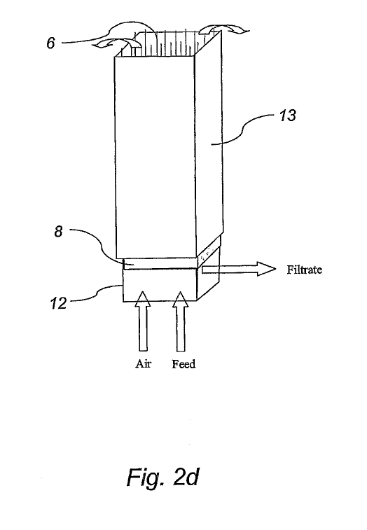

FIG. 2a illustrates a rectangular module 5 with an enclosure 13. When the feed liquid and gas are injected to the lower header 8 of the module 5, a cross-flow is created along the module.

The embodiment shown in FIG. 2b has a slightly larger enclosure 13 and the fluid can escape from the gap 16 between the upper header 7 and the enclosure 13.

The embodiment shown in FIG. 2c has a membrane module 5 which is partly enclosed with gaps 17 and 18 above and below the enclosure 13.

FIG. 2d shows a further embodiment where the module 5 has only one lower header 8 and the fibres 6 are free at the top end. In this embodiment the fibres 6 are sealed at their free ends and filtrate is withdrawn from the lower header.

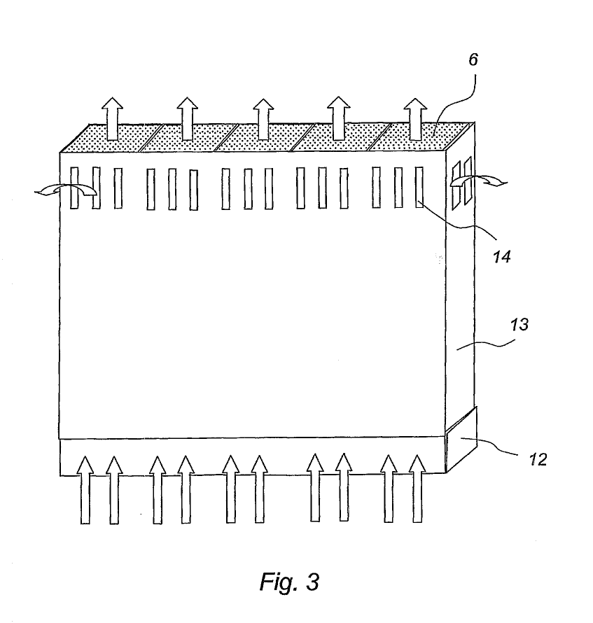

Instead of using an enclosure 13 for each individual module 5, an alternative is to use a single enclosure for an array of modules as shown in FIG. 3.

The modules need not be fully enclosed to provide a cross-flow effect, a pair of opposed walls on either side of the module or array of modules can be used to retain the flow of gas and liquid within the module. The walls can optionally cover or partly cover the modules. The walls can be of any desirable shape to suit the module configuration, including curved or arcuate shapes.

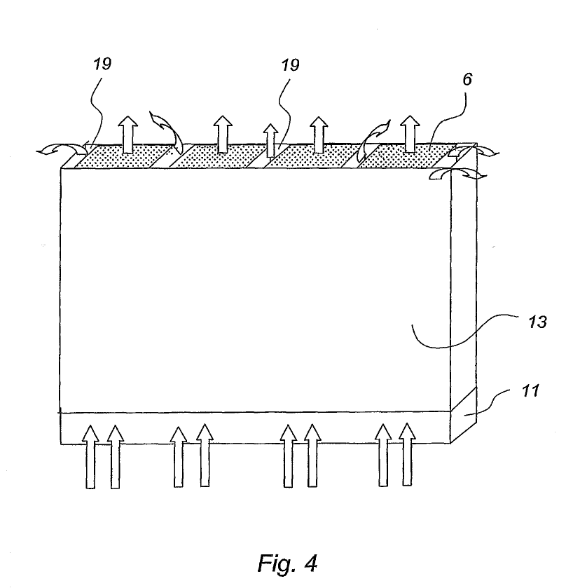

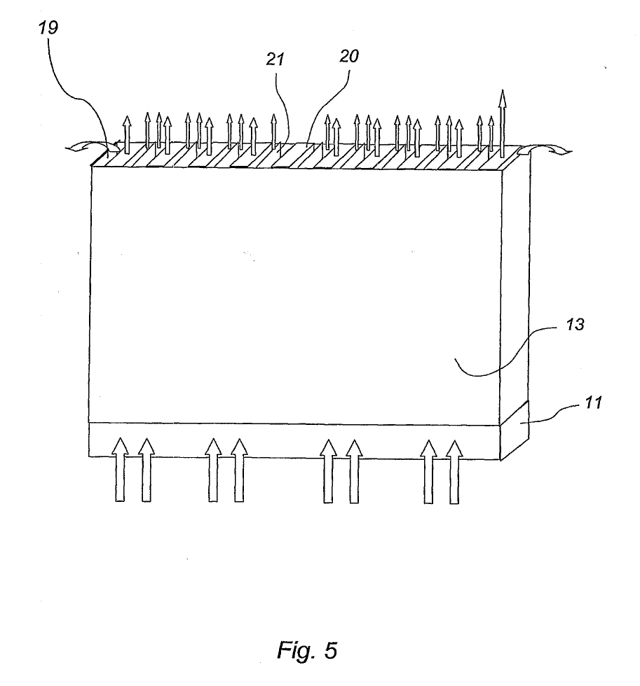

In the above examples, the gas and the concentrated feed are released through openings 14 in the enclosure 13 near the upper header 7 of the module or modules, they can also be released through the gaps 19 created within the sub-modules or between the modules as illustrated in FIG. 4.

FIG. 5 shows another arrangement of the module enclosure shown in FIG. 4. In applications with high suspended-solids feed, it is desirable to reduce the membrane fibre depth to minimize solids build-up in the module. One method, as shown in FIG. 5, is to use membrane fibre mats 20 extending along the length of the module 5 in a similar fashion to the fibre membrane bundles. To enhance the scouring effect, separators 21 may be provided between the mats or groups of mats to further confine and direct the upward flow of air along the surface of the fibre mats 20.

In the description above, gas and feed are injected from beneath the lower header 8. Alternatively, gas and feed may also be injected from the side of the lower header into the enclosure 13.

### Example

A standard submerged membrane filtration module, containing 2,200 fibres, was tested to filter mixed liquor from the bioreactor. Without the enclosure, an air flow-rate of 3 m³/hr was required to achieve a stable filtration performance at a flux of 30 L/m²/hr. When an enclosure was used, the air requirement was dropped to 2 m³/hr to achieve a similar result, a saving of air by 33%.

The filtration process provided by the invention is different from the conventional cross flow filtration process, as the gas scouring generates more efficient cleaning with less energy in the submerged cross flow filtration system. The enclosure used is of a low cost and needs little pressure tolerance.

Thus, the submerged cross flow filtration system described here combines the low capital cost of the submerged system with the efficiency of the cross flow process.

While the inventive concept has been illustrated in the embodiments and examples with reference to hollow fibre membrane modules in a vertical configuration it will be appreciated the invention is also applicable to flat sheet membranes and capillary membranes with a horizontal or non-vertical orientation.

It will be appreciated that further embodiments and exemplifications of the invention are possible without departing from the spirit or scope of the invention described.

1: A membrane filtration module of the type having a plurality of permeable, hollow membranes mounted therein, wherein, in use, a pressure differential is applied across the walls of the permeable, hollow membranes immersed in a liquid suspension containing suspended solids, said liquid suspension being applied to one surface of the permeable, hollow membranes to induce and sustain filtration through the membrane walls wherein some of the liquid suspension passes through the walls of the membranes to be drawn off as clarified liquid or permeate, and at least some of the solids are retained on or in the permeable, hollow membranes or otherwise as suspended solids within the liquid suspension, the module including a fluid retaining means at least partially surrounding the membrane module for substantially retaining at least part of fluid flowed into the membrane module.

2: A membrane filtration module according to claim 1 wherein the fluid retaining means includes a sleeve substantially surrounding the periphery of the membrane module.

3: A membrane filtration module according to claim 2 wherein the sleeve is liquid impermeable.

4: A membrane filtration module according to claim 2 wherein the sleeve is a box-like structure extending along the length of the module.

5: A membrane filtration module according to claim 2 wherein the sleeve is provided with openings at one end to allow the flow of fluid therethrough.

6: A membrane filtration module according to claim 1 wherein the fluid retaining means includes at least one pair of opposed walls positioned on either side of the module.

7: A membrane filtration module according to claim 1 wherein more than 50% of the module is enclosed by the fluid retaining means.

8: A membrane filtration module according to claim 1 wherein more than 70% of the module is enclosed by the fluid retaining means.

9: A membrane filtration module according to claim 1 wherein the fluid includes at least some of the liquid suspension.

10: A membrane filtration module according to claim 9 wherein the fluid includes gas and/or a gas/liquid mixture.

11: A membrane filtration module according to claim 1 wherein the modules are submerged in a tank containing the liquid suspension and the permeate is collected by application of a vacuum or static head to a permeate side of the membrane walls.

12: A membrane filtration module according to claim 1 wherein the membranes within the module extend at least from a lower header upward and the liquid suspension and a gas are introduced beneath the lower header or in the vicinity of the lower header of the module.

13: A membrane filtration module according to claim 12 wherein the fluid is flowed into the module through openings in the lower header.

14: A membrane filtration module according to claim 1 wherein the fluid flows along the length of the module, creating a cross flow effect.

15: A membrane filtration module according to claim 1 wherein the fluid includes either liquid or gas, or both fed continuously into the module.

16: A membrane filtration module according to claim 1 wherein the fluid includes either liquid or gas, or both fed intermittently into the module.

17: A membrane filtration system including a plurality of membrane modules according to claim 1 wherein the fluid retaining means at least partially surrounds one or more groups of said membrane modules.

18: A method of filtering solids from a liquid suspension using a plurality of permeable, hollow membranes mounted in a membrane module, the method comprising the steps of:
flowing a fluid containing said liquid suspension into said membrane module such that said liquid suspension is applied to one surface of the permeable, hollow membranes;
applying a pressure differential across the walls of the permeable, hollow membranes immersed in the liquid suspension containing suspended solids to induce and sustain filtration through the membrane walls wherein some of the liquid suspension passes through the walls of the membranes to be drawn off as clarified liquid or permeate, and at least some of the solids are retained on or in the permeable, hollow membranes or otherwise as suspended solids within the liquid suspension; and
substantially retaining at least part of the fluid flowed into the membrane module by at least partially surrounding the membrane module with a fluid retaining means.

19: A method of filtering solids from a liquid suspension according to claim 18 wherein the fluid retaining means includes a sleeve substantially surrounding the periphery of the membrane module.

20. A method of filtering solids from a liquid suspension according to claim 19 wherein the sleeve is liquid impermeable.

21: A method of filtering solids from a liquid suspension according to claim 20 wherein the sleeve is solid.

22: A method of filtering solids from a liquid suspension according to claim 19 wherein the sleeve is a box-like structure extending along the length of the module.

23: A method of filtering solids from a liquid suspension according to claim 22 wherein the sleeve is provided with openings at one end to allow the flow of fluid therethrough.

24: A method of filtering solids from a liquid suspension according to claim 19 wherein the fluid retaining means includes at least one pair of opposed walls positioned on either side of the module.

25: A method of filtering solids from a liquid suspension according to claim 19 wherein more than 50% of the module is enclosed by the fluid retaining means.

26: A method of filtering solids from a liquid suspension according to claim 19 wherein more than 70% of the module is enclosed by the fluid retaining means.

27: A method of filtering solids from a liquid suspension according to claim 19 wherein the fluid includes gas and/or a gas/liquid mixture.

28: A method of filtering solids from a liquid suspension according to claim 19 wherein the modules are submerged in a tank containing the liquid suspension and the permeate is collected by application of a vacuum or static head to a permeate side of the membrane walls.

29: A method of filtering solids from a liquid suspension according to claim 19 the membranes within the module extend from at least a lower header upward and the fluid includes the liquid suspension and a gas which are flowed into the module beneath the lower header or in the vicinity of the lower header of the module.

30: A method of filtering solids from a liquid suspension according to claim 29 wherein the fluid is flowed into the module through openings in the lower header.

31: A method of filtering solids from a liquid suspension according to claim 19 wherein the fluid is flowed along the length of the module, creating a cross flow effect.

32: A method of filtering solids from a liquid suspension according to claim 19 wherein the fluid is flowed continuously into the module.

33: A method of filtering solids from a liquid suspension according to claim 19 wherein the fluid is flowed intermittently into the module.

34: A membrane filtration module according to claim 3 wherein the sleeve is solid.
